(19) United States
(12) Patent Application Publication
(10) Pub. No.: US 2010/0228751 A1
(43) Pub. Date: Sep. 9, 2010

(54) METHOD AND SYSTEM FOR RETRIEVING UCC IMAGE BASED ON REGION OF INTEREST

(75) Inventors: Weon Geun OH, Daejeon (KR); Sungkwan Je, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/550,212

(22) Filed: Aug. 28, 2009

(30) Foreign Application Priority Data
Mar. 9, 2009 (KR) 10-2009-0019561

(51) Int. Cl. G06F 17/30; G06F 7/00

(52) U.S. Cl. 707/756; 707/E17.108; 707/E17.03

(57) ABSTRACT

A method for retrieving an image based on a region of interest (ROI) includes: requesting an image retrieval server to retrieve candidate images corresponding to a query in a mobile communication terminal; retrieving the candidate images corresponding to the query in the image retrieval server to transmit the candidate images to the mobile communication terminal; designating an ROI on one of the received candidate images in the mobile communication terminal; converting the designated ROI image into a descriptor to request the image retrieval server to retrieve ROI-based images corresponding to the descriptor; retrieving the ROI-based images in the image retrieval server to transmit the ROI-based images to the mobile communication terminal; and displaying an image selected by a user among the transmitted ROI-based images in the mobile communication terminal.

### CROSS-REFERENCE(S) TO RELATED APPLICATION(S)

The present invention claims priority of Korean Patent Application No. 10-2009-0019561, filed on Mar. 9, 2009, which is incorporated herein by reference.

### FIELD OF THE INVENTION

The present invention relates to a method and system for retrieving a user-created content (UCC) image based on a region of interest (ROI), and more particularly, to a method and system for retrieving a desired image by using an ROI of a UCC image existing on a mobile communication terminal.

### BACKGROUND OF THE INVENTION

As well-known in the art, the term ‘UCC’ stands for a user-created content. That is, UCC refers to a content produced by website user(s), which means a content made public on a web space as a product of non-occupational activity by those who do not belong to media organizations.

Specifically, UCC encompasses every individual media creation via the web such as blogs, podcastings and wikis, and includes various forms of contents including text, pictures, photos, and video clips which are generated by internet users.

Recently, users are approaching more professional level by creating contents with informational values using various tools to generate, modify and edit contents. Accordingly, UCC is not just staying at the level of self-satisfaction but is now emerging as an important means for exerting influence.

The use of UCC images is explosively increasing thanks to the spread of a high-performance portable digital camera, a high capacity storage device, and portable storage medium.

Therefore, the technique of retrieving UCC images, i.e., a UCC image retrieval technique, is required.

Conventional UCC image retrieval techniques have used a method to retrieve UCC images by inputting metadata of a desired image using a desktop personal computer or a mobile communication terminal equipped with a browser.

However, in these conventional techniques, inherent characteristics (e.g., image size, content, format, quality, etc.) of the UCC images may be easily modified due to changes of internet environment and reproduction devices, and, due to processing, re-editing, and synthesis of related contents by the user. In this case, even if the user is aware of previously inputted metadata or identifier of a UCC image, it may be impossible to retrieve the UCC image because no metadata or identifier corresponding to newly modified content exists.

### SUMMARY OF THE INVENTION

In view of the above, the present invention provides an system and method for retrieving a UCC image based on an ROI, which is capable of retrieving a desired original image through the web and the internet by using the ROI of an UCC image stored in a mobile communication terminal or downloaded through the web, the internet, or the like.

In accordance with a first aspect of the present invention, there is provided a method for retrieving an image based on a region of interest (ROI), including:

requesting an image retrieval server to retrieve candidate images corresponding to a query in a mobile communication terminal;

retrieving the candidate images corresponding to the query in the image retrieval server to transmit the candidate images to the mobile communication terminal;

designating an ROI on one of the received candidate images in the mobile communication terminal;

converting the designated ROI image into a descriptor to request the image retrieval server to retrieve ROI-based images corresponding to the descriptor;

retrieving the ROI-based images in the image retrieval server to transmit the ROI-based images to the mobile communication terminal; and

displaying an image selected by a user among the transmitted ROI-based images in the mobile communication terminal.

In accordance with a second aspect of the present invention, there is provided a mobile communication terminal, including:

a text query input and retrieval unit for retrieving candidate images corresponding to a query of a user;

a region-of-interest (ROI) designating unit for designating an ROI on one of the candidate images and converting the designated ROI image into a descriptor;

a reception unit for receiving the candidate images corresponding to the query and for receiving ROI-based images from the image retrieval server; and

a display unit for displaying the candidate images and the ROI-based images.

In accordance with a third aspect of the present invention, there is provided an image retrieval server, including:

a text query retrieval unit for retrieving candidate images corresponding to a query provided by a mobile communication terminal, from an image database (DB), and transmitting the retrieved candidate images to the mobile communication terminal; and

a region-of-interest (ROI) image retrieval unit for retrieving ROI-based images corresponding to a descriptor provided by the mobile communication terminal, from the image DB, and transmitting the retrieved ROI-based images to the mobile communication terminal.

In accordance with a fourth aspect of the present invention, there is provided a system for retrieving an image based on a region of interest (ROI), including:

an image DB for storing massive images and descriptors for the images;

a mobile communication terminal for requesting retrieval of candidate images corresponding to a query of a user, and requesting retrieval of ROI-based images; and

an image retrieval server for retrieving the candidate images corresponding to the query from the image DB, and retrieving the ROI-based images from the image DB.

### BRIEF DESCRIPTION OF THE DRAWINGS

The above features of the present invention will become apparent from the following description of embodiments, given in conjunction with the accompanying drawings, in which:

FIG. 1 is a block diagram showing a system for retrieving a UCC image based on an ROI in accordance with one embodiment of the present invention;

FIG. 2 illustrates a detailed block diagram of the mobile communication terminal shown in FIG. 1;

FIG. 3 provides a detailed block diagram of the UCC image retrieval server shown in FIG. 1;

FIG. 4 is a flowchart sequentially showing a method for retrieving a UCC image based on an ROI in accordance with the embodiment of the present invention;

FIG. 5 is a view showing a screen on which a text metadata query is inputted in accordance with the embodiment of the present invention;

FIG. 6 is a view showing a screen on which retrieved candidate images are displayed in thumbnail form in accordance with the embodiment of the present invention;

FIG. 7 is a view showing a screen on which an ROI is designated in accordance with the embodiment of the present invention;

FIG. 8 is a screen showing a screen on which images based on the ROI are displayed in thumbnail form in accordance with the embodiment of the present invention; and

FIG. 9 is a view showing a screen on which a selected image by a user is displayed in form of its original image in accordance with the embodiment of the present invention.

### DETAILED DESCRIPTION OF THE EMBODIMENTS

Hereinafter, the present invention will be described in detail with reference to the accompanying drawings.

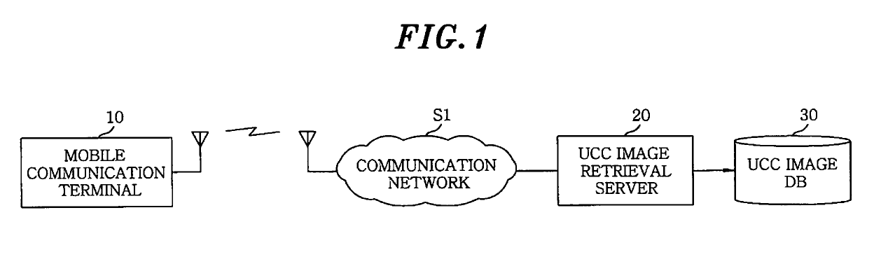

FIG. 1 is a block diagram showing a system for retrieving a UCC image based on a region of interest (ROI) in accordance with an embodiment of the present invention.

The system shown in FIG. 1 includes a mobile communication terminal 10, a UCC image retrieval server 20, and a UCC image database (DB) 30. The UCC image DB 30 stores massive images and descriptors for the images. Here, wireless communication between the mobile communication terminal 10 and the UCC image retrieval server 20 is possible by a communication network S1 (e.g., wireless network or wireless internet network capable of the wireless communication).

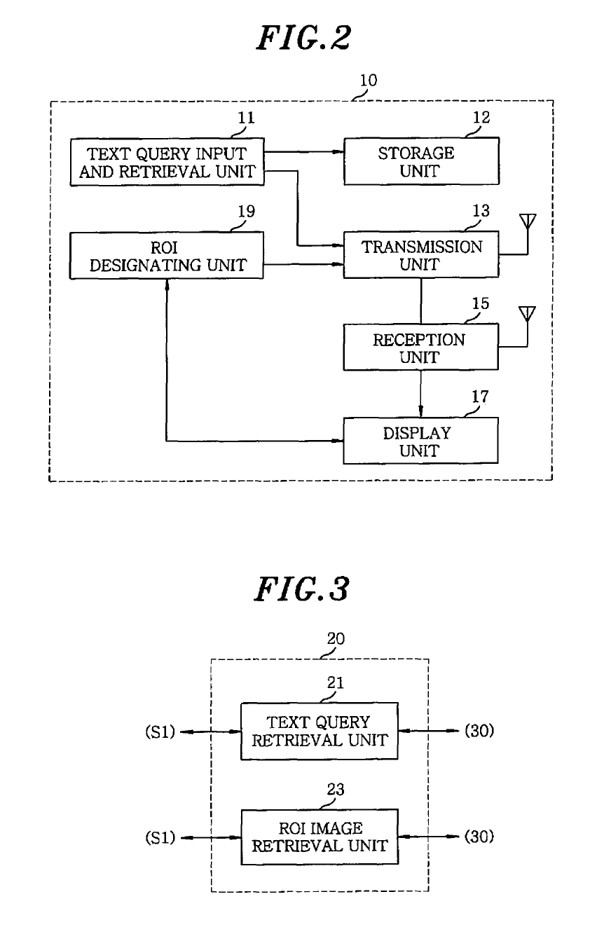

The configuration of the mobile communication terminal 10 and the UCC image retrieval server 20 will be described, with reference to FIGS. 2 and 3.

FIG. 2 illustrates a configuration of the mobile communication terminal 10 shown in FIG. 1. Referring to FIG. 2, the mobile communication terminal 10 includes a text query input and retrieval unit 11, a storage unit 12, a transmission unit 13, and a reception unit 15, a display unit 17, and an ROI designating unit 19.

The text query input and retrieval unit 11 is adapted to receive a text metadata query inputted by a user and retrieves from the storage unit 12 candidate images corresponding to the text metadata query. As a result of the retrieval, if candidate images exist, the candidate images are read out and provided to the display unit 17. However, if no candidate images exist, the text metadata query is provided to the transmission unit 13 in order to acquire candidate images from the UCC image retrieval server 20.

The transmission unit 13 transmits the text metadata query to the UCC image retrieval server 20 via the communication network S1. Then, the reception unit 15 receives candidate images corresponding to the text metadata query from the UCC image retrieval server 20 via the communication network S1, and provides those received candidate images to the display unit 17.

Further, when the transmission unit 13 receives a descriptor, which represents inherent characteristic information of an ROI image, from the ROI designating unit 19, the transmission unit 13 transmits the descriptor to the UCC image retrieval server 20 via the communication network S1. Then, the reception unit 15 receives ROI-based images, which are the most similar or the same to the ROI image, corresponding to the descriptor, from the UCC image retrieval server 20 via the communication network S1, and provides those received images to the display unit 17.

The display unit 17 displays the candidate images received from the text query input and retrieval unit 11, in thumbnail form, so that the user can select the most similar image of the candidate images to designate the ROI on the selected candidate image. In this connection, the user designates the ROI by moving and adjusting a square box which is displayed on the selected candidate image on screen of the mobile communication terminal 10.

In addition, the display unit 17 displays the ROI-based images corresponding to the descriptor received from the reception unit 15 in thumbnail form, so that the user can select his or her desired image if it exists in the displayed images. The ROI designating unit 19 receives the designated ROI image by the user from the display unit 17. Further, the ROI designating unit 19 converts the designated ROI image into the descriptor using image identification software embedded in the mobile communication terminal 10, and the converted descriptor is provided to the transmission unit 13. Here, the image identification software is a software for distinguishing an image from other images using inherent characteristic information (e.g., color, texture and a size or a figure of objects in the image) of the image.

FIG. 3 shows a configuration of the UCC image retrieval server 20 shown in FIG. 1. The UCC image retrieval server 20 includes a text query retrieval unit 21 and a ROI image retrieval unit 23.

The text query retrieval unit 21 retrieves the candidate images from the UCC image DB 30 shown in FIG. 1 on the basis of the text metadata query received from the transmission unit 13 of the mobile communication terminal 10 via the communication network S1. The retrieved candidate images are transmitted to the reception unit 15 of the mobile communication terminal 10 via the communication network S1.

The ROI image retrieval unit 23 retrieves the ROI-based images similar to the ROI image, from the UCC image DB 30, by comparing the descriptor of the ROI image received from the transmission unit 13 of the mobile communication terminal 10 to descriptors of images in the UCC image DB 30. The ROI-based images are transmitted to the reception unit 15 of the mobile communication terminal 10 via the 4, communication network S1.

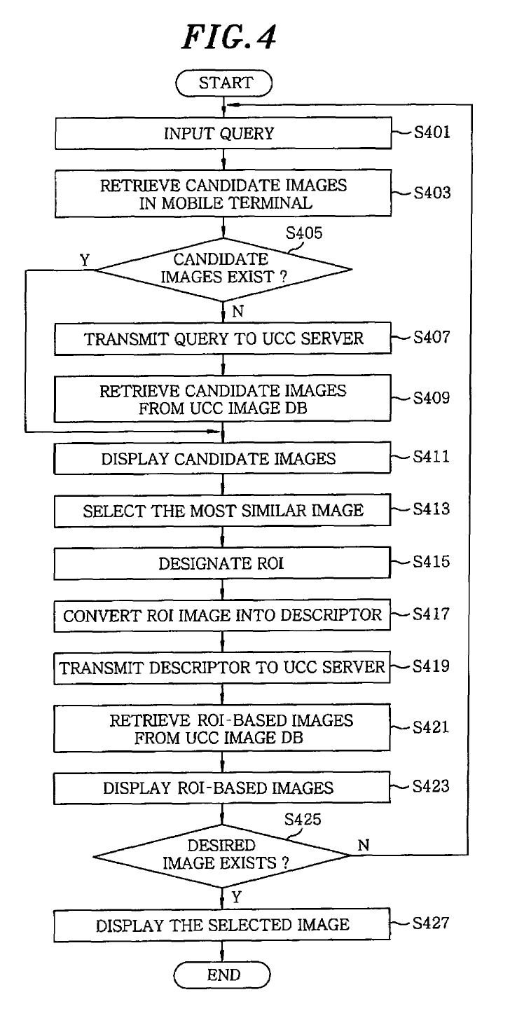

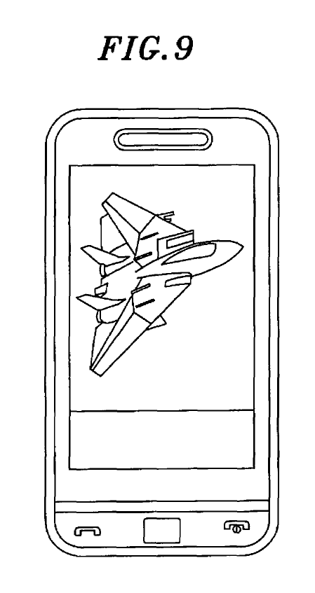

Hereinafter, a procedure of retrieving a UCC image based on an ROI in accordance with the embodiment of the present invention having the above-described configuration will be described in detail with reference to FIG. 4 to FIG. 9.

FIG. 4 is a flowchart sequentially showing a method for retrieving a UCC image based on an ROI.

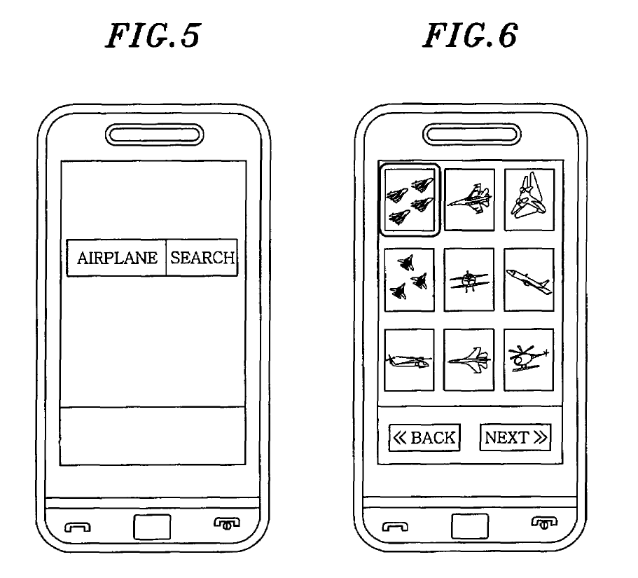

First, in step S401, a user inputs a text metadata query. Then, the text query input and retrieval unit 11 in the mobile communication terminal 10 retrieves candidate images corresponding to a text metadata query inputted by a user from the storage unit 12 within the mobile communication terminal 10 in step S403. For example, referring to FIG. 5, a query saying ‘airplane’ is retrieved.

As a result of the retrieval in step S403, if similar candidate images exist in the storage unit 12 in step S405, the process goes to the step S411 to display the candidate images.

On the other hand, as a result of the retrieval in step S403, if there are no similar candidate images in the storage unit 12 in step S405, the text metadata query is provided to the transmission unit 13. Then, the transmission unit 13 transmits the text metadata query to the text query retrieval unit 21 in the UCC image retrieval server 20 via the communication network Si in step S407.

The text query retrieval unit 21 in the UCC image retrieval server 20 retrieves candidate images from the UCC image DB 30 on the basis of the text metadata query in step S409, and transmits the retrieved candidate images to the reception unit 15 of the mobile communication terminal 10 via the communication network S1.

The reception unit 15 receives the candidate images corresponding to the text metadata query to provide the candidate images to the display unit 17. Then, the display unit 17 displays the candidate images on screen in thumbnail form in step S411, as shown in FIG. 6.

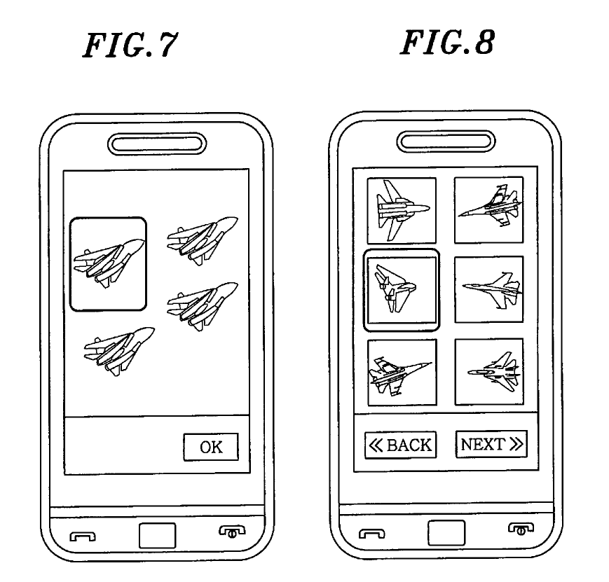

Next, in step S413, the user selects one candidate image which is most similar to the desired image among the displayed candidate images of the thumbnail form. And then, the user designates an ROI by moving and adjusting a marked square box on the selected image in step S415, as shown in FIG. 7. The ROI designating unit 19 receives the ROI designated by the user and converts the designated ROI image into a descriptor using the image identification software in step S417. The descriptor is delivered to the transmission unit 13.

The transmission unit 13 transmits the descriptor to the ROI image retrieval unit 23 in the UCC image retrieval server 20 via the communication network S1 in step S419.

The ROI image retrieval unit 23 retrieves ROI-based images, which are the most similar to the ROI image, by ;comparing the descriptor of the ROI image to descriptors of images in the UCC image DB, in step S421. The ROI-based images are transmitted to the reception unit 15 of the mobile communication terminal 10 via the communication network S1.

The reception unit 15 receives the ROI-based images and provides them to the display unit 17.

Then, the display unit 17 displays the ROI-based images received from the reception unit 15 in thumbnail form in priority order based on the similarity to the ROI image in step S423, as shown in FIG. 8. At this time, the user determines whether there is a desired image among the displayed images in step S425. If the user selects one image in step S425, the display unit 17 displays the selected image in its original form in step S427. On the other hand, if the user determines there is no desired image among the displayed ROI-based images in step S425, the user may perform the process all over again so that the user may query another text metadata or select another candidate image.

Through the above process, the present invention can solve the problem of the prior art that a UCC image cannot be retrieved due to the absence of metadata or identifier corresponding to a newly modified content, by retrieving a desired original image via the web and the internet using an ROI of the UCC image stored in a mobile communication terminal or downloaded via the web and the internet.

Furthermore, the present invention is advantageous in that it allows the user to retrieve a desired UCC image at a high speed and efficiently from the mobile communication terminal by providing a method and system for retrieving a UCC image based on an ROI, thereby expediting the development of the UCC industry.

While the invention has been shown and described with respect to the embodiments, it will be understood by those skilled in the art that various changes and modification may be made without departing from the scope of the invention as defined in the following claims.

What is claimed is:

1. A method for retrieving an image based on a region of interest (ROI), comprising:
requesting an image retrieval server to retrieve candidate images corresponding to a query in a mobile communication terminal;
retrieving the candidate images corresponding to the query in the image retrieval server to transmit the candidate images to the mobile communication terminal;
designating an ROI on one of the received candidate images in the mobile communication terminal;
converting the designated ROI image into a descriptor to request the image retrieval server to retrieve ROI-based images corresponding to the descriptor retrieving the ROI-based images in the image retrieval server to transmit the ROI-based images to the mobile communication terminal; and
displaying an image selected by a user among the transmitted ROI-based images in the mobile communication terminal.

2. The method of claim 1, further comprising:
retrieving candidate images corresponding to the query from the mobile communication terminal, before said requesting the image retrieval server to retrieve the candidate images.

3. The method of claim 2, wherein the query is a text metadata query.

4. The method of claim 2, further comprising:
if the candidate images corresponding to the query exist in a storage unit within the mobile communication terminal, reading out and outputting the candidate images from the storage unit.

5. The method of claim 1, wherein the candidate images are displayed in thumbnail form.

6. The method of claim 1, wherein the ROI-based images are displayed in thumbnail form.

7. A mobile communication terminal, comprising:
a text query input and retrieval unit for retrieving candidate images corresponding to a query of a user;
a region-of-interest (ROI) designating unit for designating an ROI on one of the candidate images and converting the designated ROI image into a descriptor;
a reception unit for receiving the candidate images corresponding to the query and for receiving ROI-based images from the image retrieval server; and
a display unit for displaying the candidate images and the ROI-based images.

8. The mobile communication terminal of claim 7, wherein the text query input and retrieval unit reads out the candidate images corresponding to the query from a storage unit within a mobile communication terminal if the candidate images exist in the storage unit, and provides the candidate images to the display unit.

9. The mobile communication terminal of claim 8, wherein the query is a text metadata query.

10. The mobile communication terminal of claim 7, wherein the descriptor represents inherent characteristic information of the ROI image.

11. The mobile communication terminal of claim 10, wherein the inherent characteristic information includes any one of the size, format, and resolution of the selected image.

12. The mobile communication terminal of claim 7, wherein the display unit displays the candidate images and the ROI-based images in thumbnail form.

13. An image retrieval server, comprising:
a text query retrieval unit for retrieving candidate images corresponding to a query provided by a mobile communication terminal, from an image database (DB), and transmitting the retrieved candidate images to the mobile communication terminal; and
a region-of-interest (ROI) image retrieval unit for retrieving ROI-based images corresponding to a descriptor provided by the mobile communication terminal, from the image DB, and transmitting the retrieved ROI-based images to the mobile communication terminal.

14. The image retrieval server of claim 13, wherein the query is a text metadata query.

15. A system for retrieving an image based on a region of interest (ROI), comprising:
an image DB for storing massive images and descriptors for the images;
a mobile communication terminal for requesting retrieval of candidate images corresponding to a query of a user, and requesting retrieval of ROI-based images; and
an image retrieval server for retrieving the candidate images corresponding to the query from the image DB, and retrieving the ROI-based images from the image DB.

16. The system of claim 15, wherein the mobile communication terminal includes:
a text query input and retrieval unit for retrieving the candidate images corresponding to the query of the user;
a region-of-interest (ROI) designating unit for converting the ROI image designated by the user into a descriptor;
a transmission unit for transmitting the query and the descriptor to the image retrieval server via a network;
a reception unit for receiving the candidate images corresponding to the query, and receiving the ROI-based images corresponding to the descriptor from the image retrieval server; and
a display unit for displaying the candidate images and the ROI-based images.

17. The system of claim 15, wherein the image retrieval server retrieves the ROI-based images relatively similar to the ROI image, by comparing the descriptor of the ROI image to descriptors of images within the image DB.

18. The system of claim 16, wherein the descriptor represents inherent characteristic information including any one of the size, format and resolution of the ROI image.

19. The system of claim 16, wherein the text query input and retrieval unit reads out the candidate images corresponding to the query from a storage unit within the mobile communication terminal if the candidate images exist in the storage unit, and provides the candidate images to the display unit.

20. The system of claim 19, wherein the query is a text metadata query.
